(19) United States
(12) Patent Application Publication
(10) Pub. No.: US 2013/0134270 A1
(43) Pub. Date: May 30, 2013

(54) ELECTRICAL DEVICE SUPPORT

(71) Applicants: Jean-Guy GAGNE, Etobicoke (CA); James W. ROGERS, Toronto (CA)

(72) Inventors: Jean-Guy GAGNE, Etobicoke (CA); James W. ROGERS, Toronto (CA)

(73) Assignee: Brainwave Research Corporation, Woodbridge (CA)

(21) Appl. No.: 13/690,849

(22) Filed: Nov. 30, 2012

Related U.S. Application Data
(60) Provisional application No. 61/565,223, filed on Nov. 30, 2011.

(51) Int. Cl. F16M 13/02

(52) U.S. Cl. CPC F16M 13/02
USPC 248/205.1

(57) ABSTRACT

An electrical device support assembly that includes a bracket member that can be mounted on a building wall stud during new construction, and a frame, external to the wall substrate, that is engageable with the bracket member through an opening in the wall substrate. The bracket member may have a plurality of flange elements extending from the perimeter edge of the opening in an internal direction from the wall substrate. The flange elements define the periphery of an opening to be made in the wall substrate and thus act as a template for cutting the substrate opening after substrate is installed flush with the bracket member

The benefit of provisional application 61/565,223, filed Nov. 30, 2011 on behalf of inventors Jean-Guy Gagne and James Rogers, is claimed under 35 U.S.C. 119(e).

### BACKGROUND

This disclosure is related to installation of electrical components in building walls, more particularly, to installation of support structure for electrical boxes, low voltage devices and the like in new or existing building construction.

Electrical switches and receptacles require electrical boxes to meet existing electrical codes. In new house or building construction, line current electrical boxes typically are attached to wall studs or joists before drywall or equivalent sheet material is applied to enclose the wall space. Openings can be cut in the sheet material to accommodate the boxes to be mounted in known positions. Although low voltage applications, such as network communications, need not meet line voltage box requirements, means must be provided in the wall to provide appropriate access to internal wiring. As the wall substrate, such as drywall, is fixed to the wall stud structure before connection to an electrical device can be completed, needs exist for efficiently locating and creating an opening in the substrate and for engaging the device to the wall.

Cutting an opening in the wall substrate that is appropriately sized and placed can be time consuming. In new building construction, electrical outlets, switches, and the like, are generally placed proximate a wall stud. A known means for addressing the above described needs is installment of a permanent template, which defines the opening periphery, at a predetermined location of the wall structure before the wall substrate is added. As the opening is to be cut after the substrate has enclosed the wall studs, difficulty in accurately locating the template must be overcome. To this end, templates have been provided with raised surfaces that are not flush with the stud so that the installer can attempt to locate the template, either by “feel” or by observance of a bulge in the substrate. This approach still involves considerable expenditure of time. A further disadvantage is that non-uniformity in the wall substrate surface in the area of the opening can result, as the permanently installed template extends outwardly from the stud.

Needs thus exist for a more accurate and easier way to facilitate installation of electrical devices in building walls, both in the formation of the substrate opening and in the provision of support for the electrical devices. Elimination of substrate surface non-uniformity is a further objective.

### SUMMARY OF DISCLOSURE

The needs described above are fulfilled, at least in part, by an electrical device support assembly that includes a bracket member that can be mounted on a building wall stud during new construction, and a frame, external to the wall substrate, that is engageable with the bracket member through an opening in the wall substrate. The bracket member has opposite planar surfaces with a generally rectangular opening, one side of the bracket member configured to be mounted to a wall stud in contact with one of the planar surfaces. The bracket member may include bent tabs that permit easy alignment of the bracket member to a side of the stud.

The bracket member may have a plurality of flange elements extending from the perimeter edge of the rectangular opening in an internal direction from the wall substrate. The flange elements define the periphery of an opening to be made in the wall substrate and thus act as a template for cutting the substrate opening after substrate is installed flush with the bracket member. For this purpose, a cutting tool, such as a router, may be used. The tip of a router bit can be punched through the wall substrate at a position that will be within the confines of the intended opening. The depth of the cutting portion of the bit can be set to the thickness of the substrate. During cutting operation, the tool may be moved in any direction until the non-cutting tip of the tool bit makes contact with the bracket flange. Cutting can then proceed along the periphery defined by the bracket flanges.

The frame is configured to surround the wall substrate opening. Tongue elements extend inwardly of the wall opening from an inner planar surface of the frame. When the frame is linked to the bracket member, the frame is secured to the wall substrate to support an electrical device coupled thereto. The frame may contain engagement components for mating with the electrical device. Each of the tongue elements may contain a toothed surface that can mate with corresponding sprung element retainers of the bracket member. The sprung elements are recessed inwardly from the edge of the bracket member opening to avoid interfering with the cutting operation. After the cutting operation, the frame tongue elements may be inserted by hand through the opening to make contact with the sprung elements until the sprung elements engage the teeth of the tongue elements and secure the inner planar surface of the frame flush to the wall substrate.

Additional sprung elements may be utilized to aid retention. A retainer element may include a slotted flange that may be used to disengage the retainer from the frame tongue if removal of the frame is required. A tool, such as a screwdriver or the like, can be inserted through the opening to bias the sprung element accordingly.

The bracket member may additionally include a generally perpendicular gusset member for mounting to a side of the stud. Such provision may be beneficial to provide additional support strength for heavier electrical devices, such as boxes used in line voltage applications. The bracket member may further include threaded holes, such as an integral speed nut, to provide further support for the electrical device.

The assembly may also be implemented for so-called “rework construction” applications, wherein access to electrical devices is desired in pre-existing walls. The bracket may include a side portion having perforations for detachment of the side portion from the bracket member to permit insertion of the bracket member through a substrate opening to be thereafter linked to the frame as described above.

Additional advantages of the present disclosure will become readily apparent to those skilled in this art from the following detailed description, wherein only the preferred embodiments of the invention are shown and described, simply by way of illustration of the best mode contemplated of carrying out the invention. As will be realized, the invention is capable of other and different embodiments, and its several details are capable of modifications in various obvious respects, all without departing from the invention. Accordingly, the drawings and description are to be regarded as illustrative in nature, and not as restrictive.

### BRIEF DESCRIPTION OF DRAWINGS

Various exemplary embodiments are illustrated by way of example, and not by way of limitation, in the figures of the accompanying drawings in which like reference numerals refer to similar elements and in which:

FIG. 1a is an exploded perspective view of a low voltage device and frame assembly installed in accordance with the present disclosure;

FIG. 1b is a perspective view of the assembled low voltage device and frame assembly shown in FIG. 1a;

FIG. 2a is a front view of the bracket and stud shown in FIG. 1a;

FIG. 2b is an angled back view of the structure shown in FIG. 2a;

FIG. 3a is a front view of the cutaway drywall covering the bracket and stud shown in FIG. 2a;

FIG. 3b is a side view of the structure shown in FIG. 3a;

FIG. 4a is a top view of the assembly shown in FIGS. 3a-b;

FIG. 4b is a perspective view of the assembly shown in FIG. 4a;

FIG. 4c is a front view of the assembly shown in FIG. 4a;

FIG. 4d is a side view of the assembly shown in FIG. 4a;

FIG. 4e is a detail view taken from FIG. 4d;

FIG. 4f is a rear perspective view of the assembly shown in FIG. 4a;

FIG. 5a is a perspective view of an alternative embodiment of the present disclosure;

FIG. 5b is a perspective view of the embodiment shown in FIG. 5a prior to assembly;

FIG. 5c is a perspective view of the assembled frame and bracket shown in FIG. 5b;

FIG. 5d is a front view of the assembly shown in FIG. 5c;

FIG. 5e is a side view of the assembly shown in FIG. 5d;

FIG. 6 is a perspective view illustrating use of the bracket shown FIG. 5a as a template;

FIG. 7a is an exploded perspective view of an alternative embodiment of the present disclosure;

FIG. 7b is an unexploded view of the assembly shown in FIG. 7a.

FIG. 8a is a perspective view illustrating removal of the assembly shown in FIGS. 7a-7b;

FIG. 8b is the rear perspective view of the structure shown in FIG. 8a;

FIG. 8c is detail view taken from FIG. 8b;

FIG. 9a is an exploded perspective view another of the present disclosure;

FIG. 9b is an unexploded perspective view of the assembly shown in FIG. 9a;

FIG. 10a is a perspective view illustrating removal of the frame from the bracket shown in FIGS. 9a-b;

FIG. 10b is a front view of the structure shown in FIG. 10a;

FIG. 10c is a section view of the structure shown in FIG. 10b;

FIG. 10d is a detail view taken from FIG. 10c;

FIG. 11 is a perspective view illustrating formation of a substrate opening;

FIG. 12a is an exploded view of another embodiment of the present disclosure;

FIG. 12b is an unexploded view of the assembly shown in FIG. 12a

FIG. 12c is a rear perspective view of the assembly shown in FIG. 12b;

FIG. 12d is a detail view taken from FIG. 12c;

FIG. 13a is an exploded view of another embodiment of the present disclosure;

FIG. 13b is an unexploded view of the assembly shown in FIG. 13a;

FIG. 14a is an exploded view another embodiment of the present disclosure;

FIG. 14b is an unexploded view of the assembly shown in FIG. 14a;

FIG. 15a is an exploded perspective view of yet another embodiment of the present disclosure;

FIG. 15b is an unexploded view of the assembly shown in FIG. 15a;

FIG. 15c is a front view of the assembly shown in FIG. 15b;

FIG. 15d is a section view of FIG. 15c; and

FIG. 15e is a detail view taken from FIG. 15d.

### DETAILED DISCLOSURE

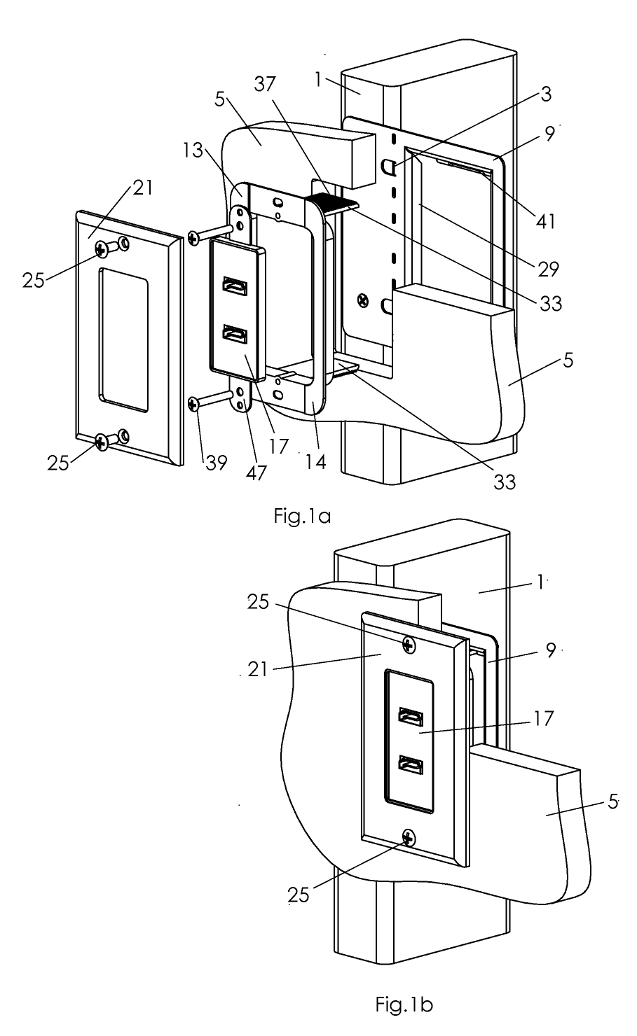

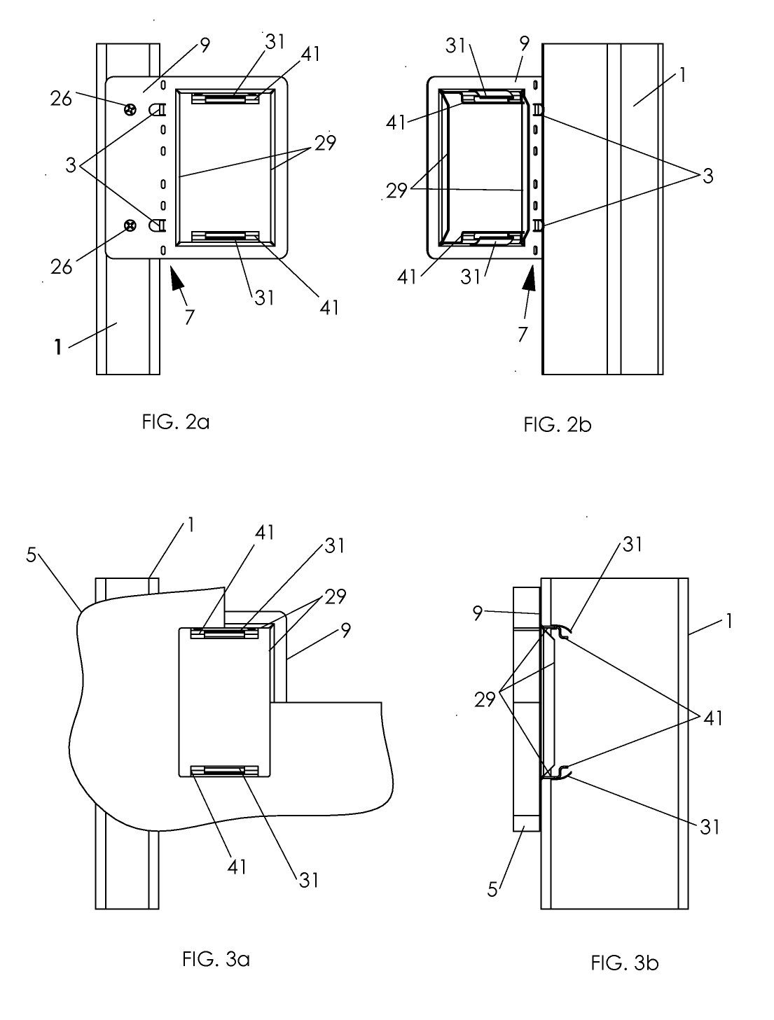

FIGS. 1a and 1b illustrate a low voltage device 17 and frame assembly, including frame 13 and bracket member 9, installed for new building construction in a preferred embodiment. Various features are shown in more detail in FIGS. 2a-4f.

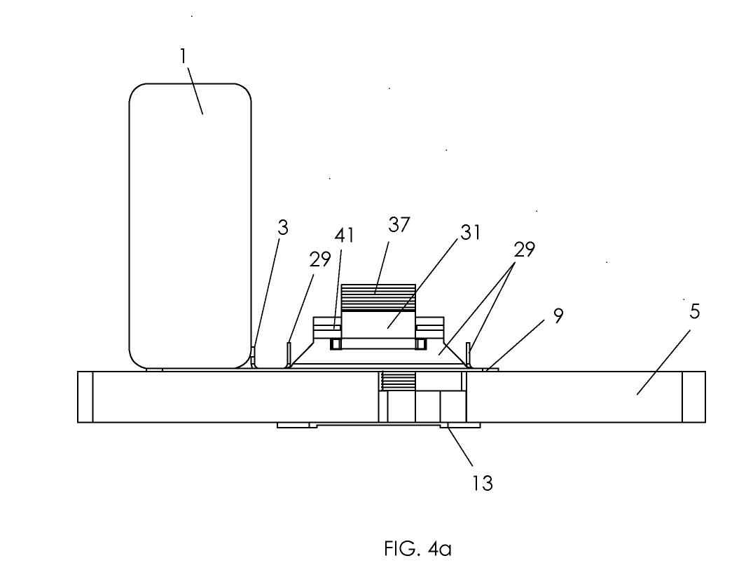

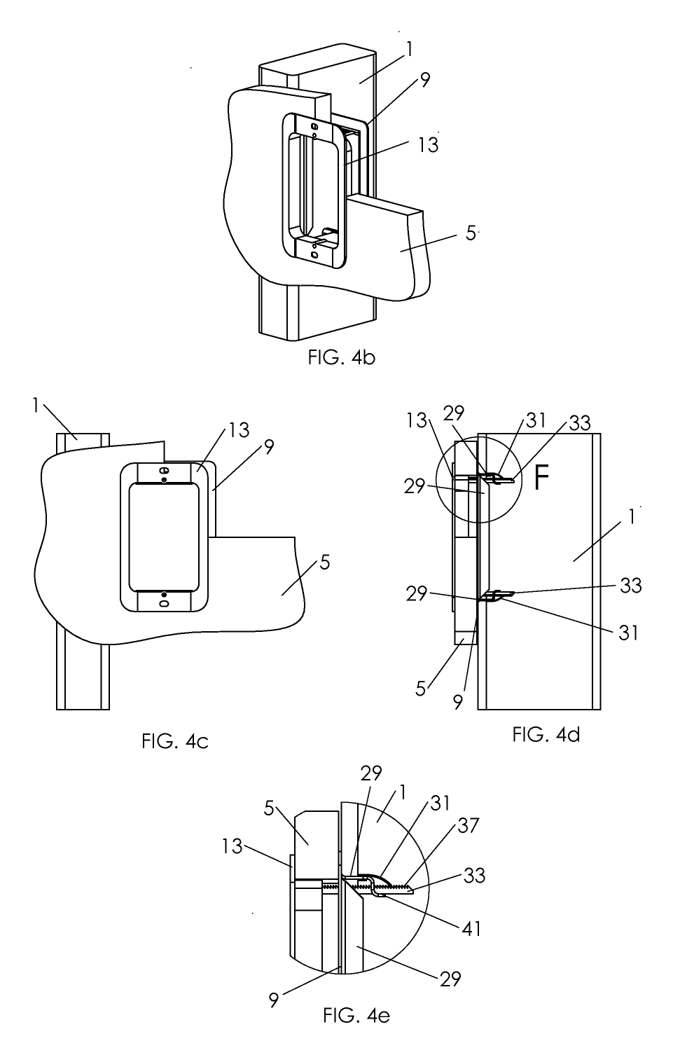

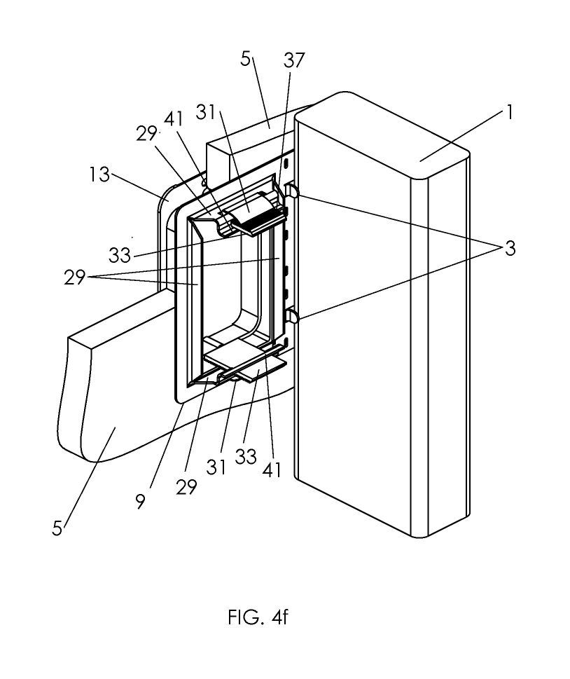

Metal bracket 9, attached to wall stud 1, sandwiches drywall 5 (partially cutaway) to frame 13. A side portion of bracket 9 may be fixed to the edge of stud 1 by, for example, screws 26 as shown in FIG. 2a. Bent tabs 3 on bracket 9 help position bracket 9 in correct alignment relative to stud 1, making installation easier and more secure. Flanges 29 extend inwardly from the perimeter of the bracket opening, as shown in FIGS. 2b, 3b and 4a. Sprung retainers 31 and tongue supports 41 extend from the top and bottom flanges 29, respectively, as best seen in FIG. 3b. Frame 13 comprises upper and lower tongues 33, having toothed surfaces 37, as shown in FIGS. 1a and 4a.

Installation of the assembly is implemented after bracket member 9 is secured to stud 1 and the wall substrate, exemplified herein as a drywall substrate, is mounted to the wall studs. The outer planar surface of bracket member 9 sits flush with the back surface of drywall 5. An opening is then formed in the drywall as illustrated in FIG. 11. Recessed inward extending flanges 29 of bracket 9 act as a drywall cutting template. Cutting bit 51 of a router tool or the like can be inserted through the dry wall at the point 71 of the cutting bit guide tip. After activation of the cutting tool, the cutting bit can be moved from the insertion point until the guide tip abuts flange 29 of the bracket member 9. The cutting bit is then moved with its guide tip running along the inside perimeter flange 29 of bracket member 9. Cutting bit 51 is best used with a depth gage (not shown) to ensure that the guide tip, not the cutting edge of the bit, runs along flange 29 and that the cut is perpendicular to front surface of the drywall 5. Retainer assembly 58 is recessed beyond the extent of flange 29 to permit cutting bit 51 to pass without interference, as illustrated in FIG. 3b.

Retainer 58, comprising tongue supports 41 and sprung retainers 31, receive tongues 33 with teeth 37 of frame 13, as shown in FIGS. 4a-4f. Tongues 33 with teeth 37, located on the top and bottom of frame 13, penetrate the top and bottom of bracket member 9 opening between tongue support 41 and sprung retainer 31. By inserting a hand through frame 13 and bracket 9 and squeezing frame 13 and bracket 9, drywall 5 is sandwiched securing frame 13 in place. Teeth 37 are retained by sprung retainer 31. As frame 13 is pushed into bracket 9, teeth 37 on tongues 33 ratchet against sprung retainers. Tongue support 41 ensures that tongue 33 does not deflect away from sprung retainer to attain proper engagement. The ratcheting of teeth 37 in sprung retainers 31 accommodates different thicknesses of drywall, as well as different types of wall substrate and cladding that may be used. Low voltage device 17 is secured to frame 13 with threaded fasteners 39 and cover plate 21 is screwed into device plate 47 with fasteners 25.

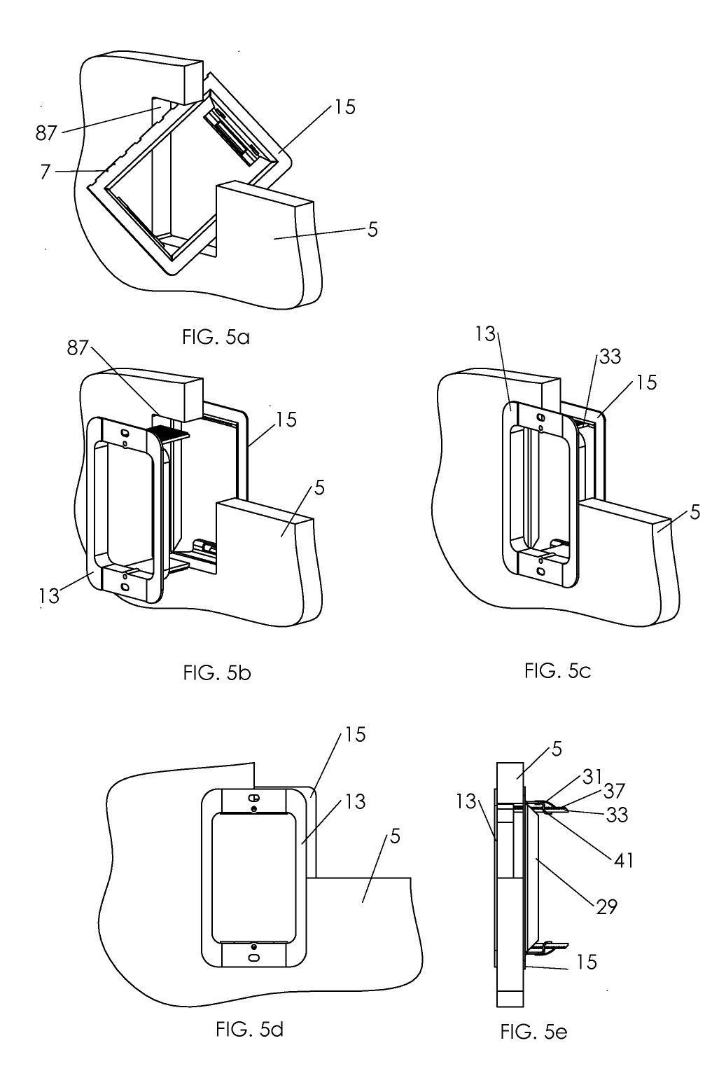

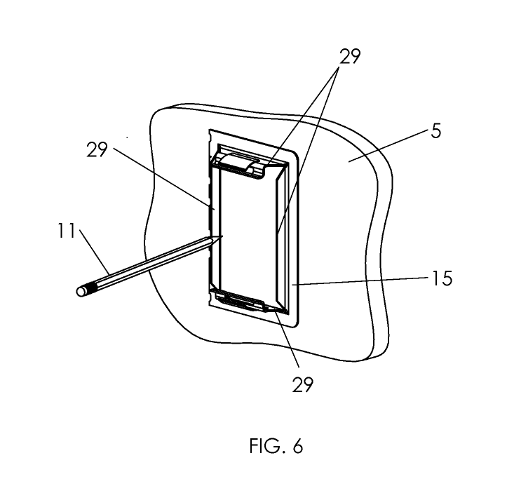

The bracket and frame assembly may also be utilized for installation of electrical devices in pre-existing building walls, known as “re-work” building construction. Bracket member 9 can be decreased in width by cutting or repeated bending at perforated line 7, illustrated in FIGS. 2a-2b to allow for insertion through hole in drywall 5. FIGS. 5a-e illustrate frame 13 and bracket member 15 implemented in a rework installation in which existing drywall 5 prevents access to studs. Bracket member 9, shown in earlier figures, has been modified by disengagement at perforation line 7. During installation, bracket 15 is inserted into opening 87 in drywall 5, as shown FIG. 5a. Bracket 15 is held by hand on the backside of drywall 5 while frame 13 is inserted into hole 87, as shown in FIGS. 5b and 5c. Teeth 37 on tongues 33 engage sprung retainers 31 and tongue supports 41 as described above with respect to FIGS. 4a-f. Although a cut bracket 15 is shown, a distinct back bracket for rework that does not require cutting is envisioned.

The opening in drywall 5 may be placed at any desired location away from a stud, using bracket member 15 as a template. As shown in FIG. 6, the planar surface of bracket member 15 is placed against drywall 5 with flanges 29 facing outwardly. The periphery of flanges 29 are used to scribe a line along its perimeter to define the wall opening 87. After insertion of the bracket member 15 through the opening as shown in FIG. 5a, the planar surface of bracket member 15 surrounds opening 87, as shown in FIG. 5e, to provide appropriate ratcheting with frame 13.

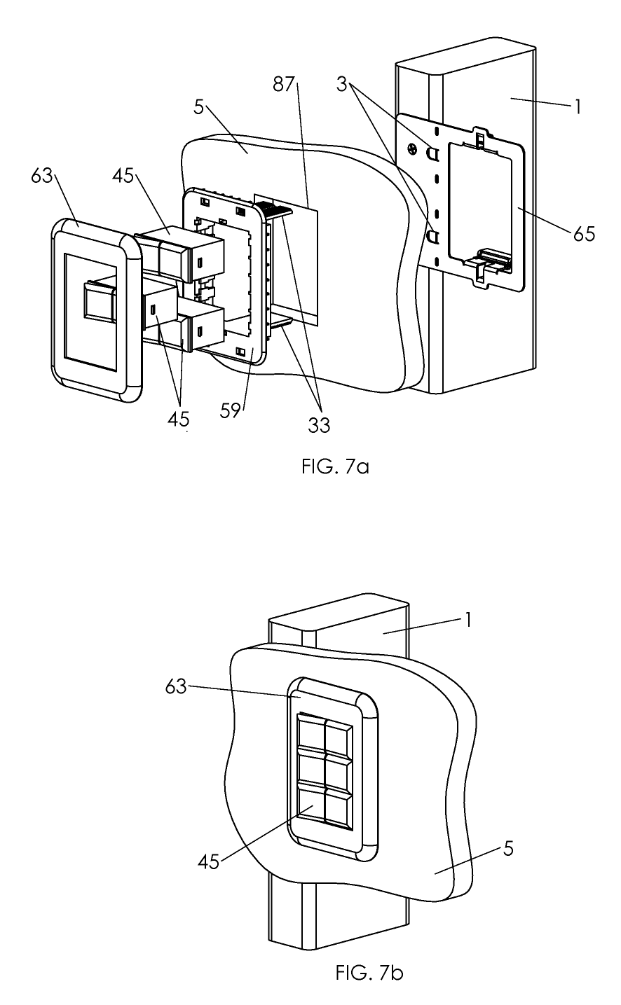

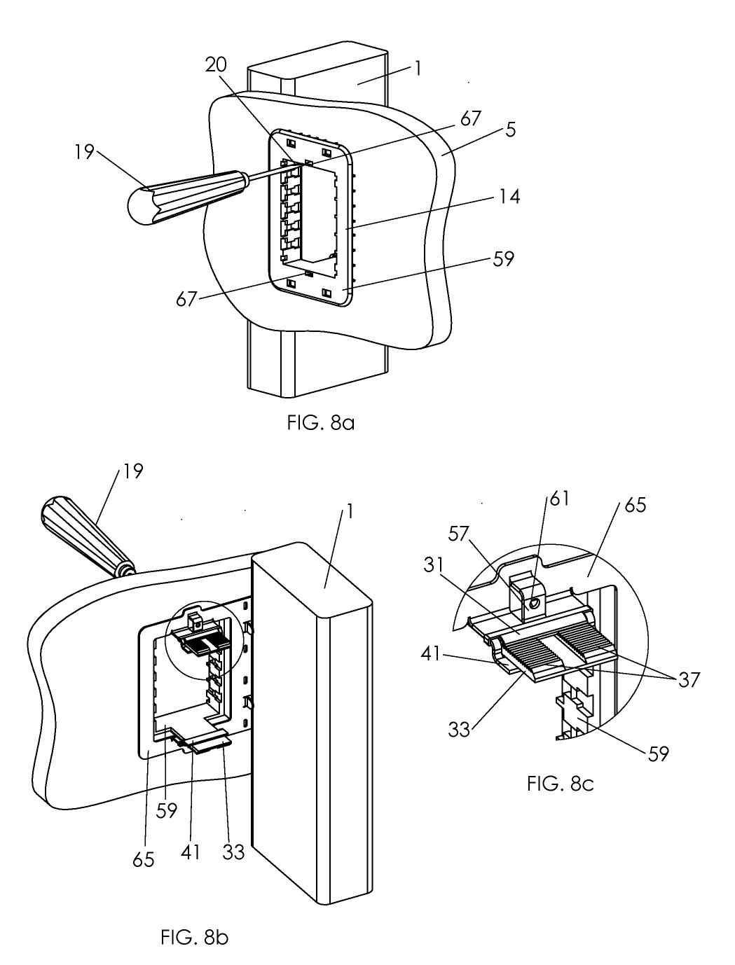

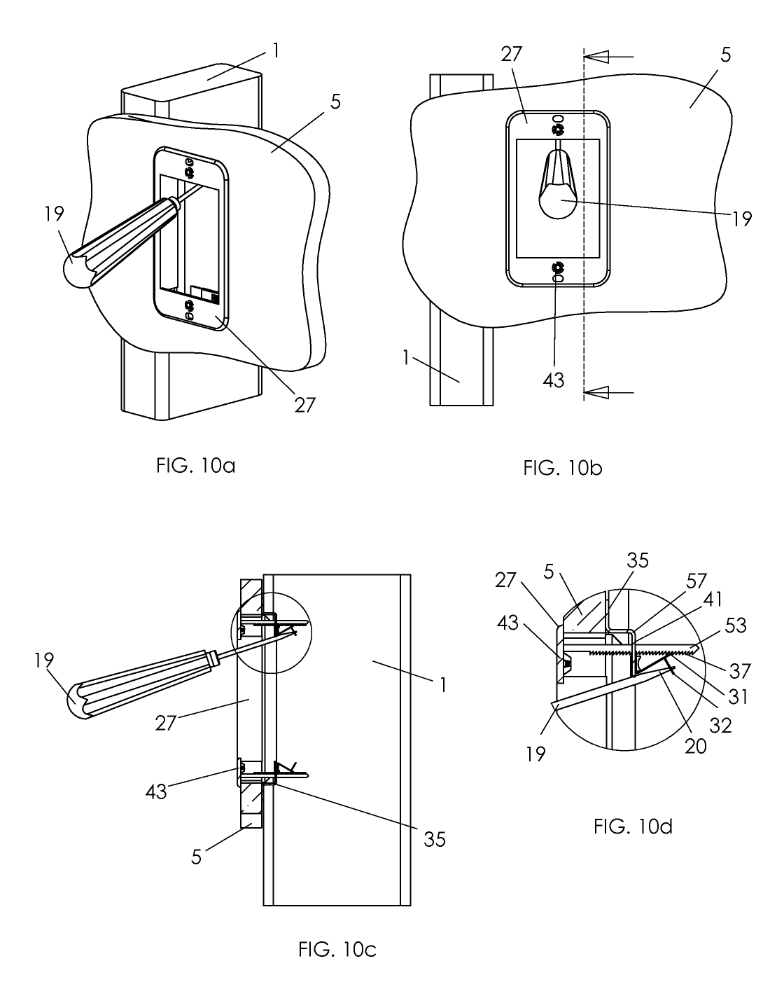

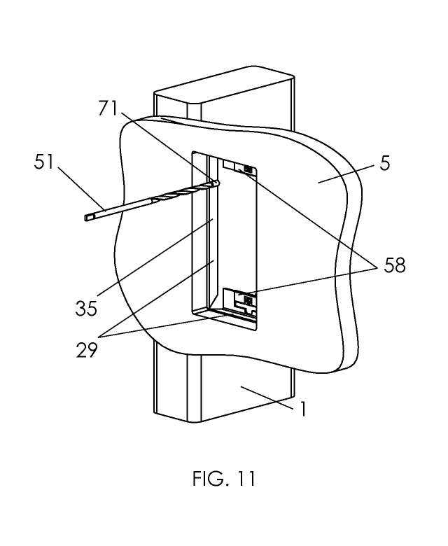

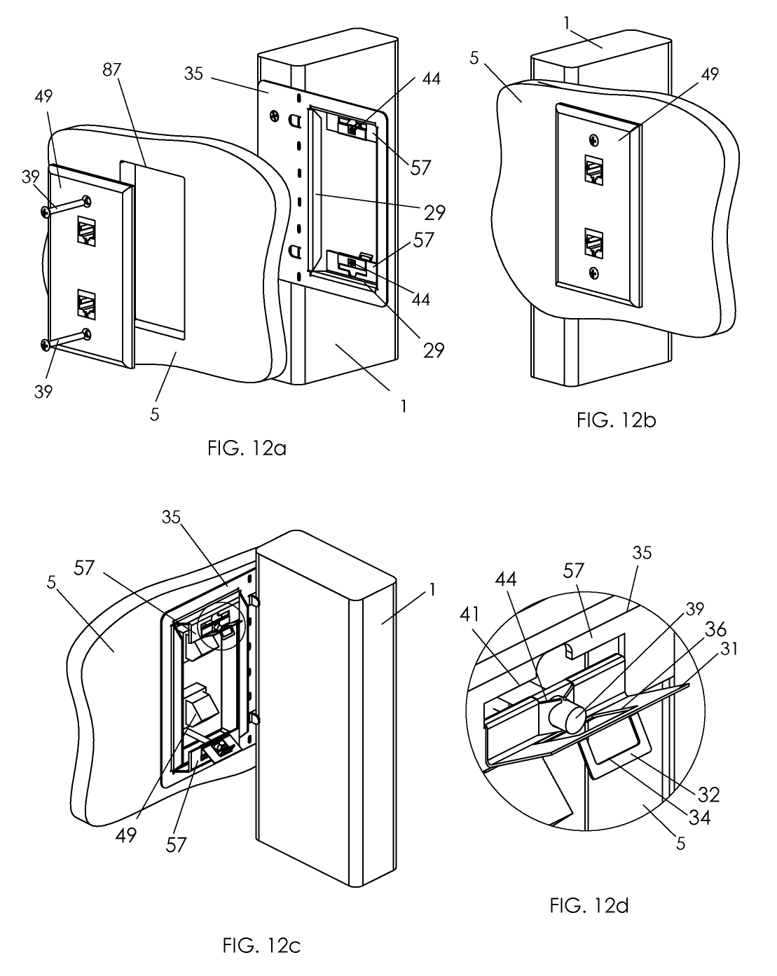

An alternative assembly embodiment is illustrated in FIGS. 7a-b. Frame 59 is ratcheted into bracket 65 mounted on stud 1 to sandwich drywall 5 through hole 87. Frame 59 is formed with features along its inner sides that can mate with low voltage switches 45 and cover plate 63 that snap into the frame 59. Frame 59 can be removed from bracket 65 at a later time if desired, as illustrated in FIGS. 8a-c. Teeth 37 on tongues 33 on frame 59 are retained by sprung retainers 31 and supported by tongue supports 41 on bracket 65. To remove frame 59 from bracket 65, a small screwdriver 19, for example, is inserted into holes 67 in frame 59. Tip 20 passes through the frame front flange 14 and wedges between sprung retainer 31 and tongue 33, thus disengaging sprung retainer 31 from teeth 37. Frame 59 can then be pulled from bracket 65. Should it thereafter be desired to install a conventional low voltage device, not shown, screws can be mounted through the device plates to thread into holes 61 in recessed surface 57 of bracket 65. For such installation, frame 59, which has been removed, is not necessary. As shown in FIGS. 12a-d, device cover plate 49 can be mounted to bracket member 65 without an intervening frame. Metal speed nuts 44, supported by recessed surface 57, receive device mounting screws 39 and speed installation of device cover plate. Spring sheet metal, stamped to match one half of a single thread in both size and pitch, are cantilevered on each side of screw 39. Clearance hole 36 in removal flange 32 and leverage hole 34 are more clearly shown in FIG. 12d, described in FIG. 10a-d.

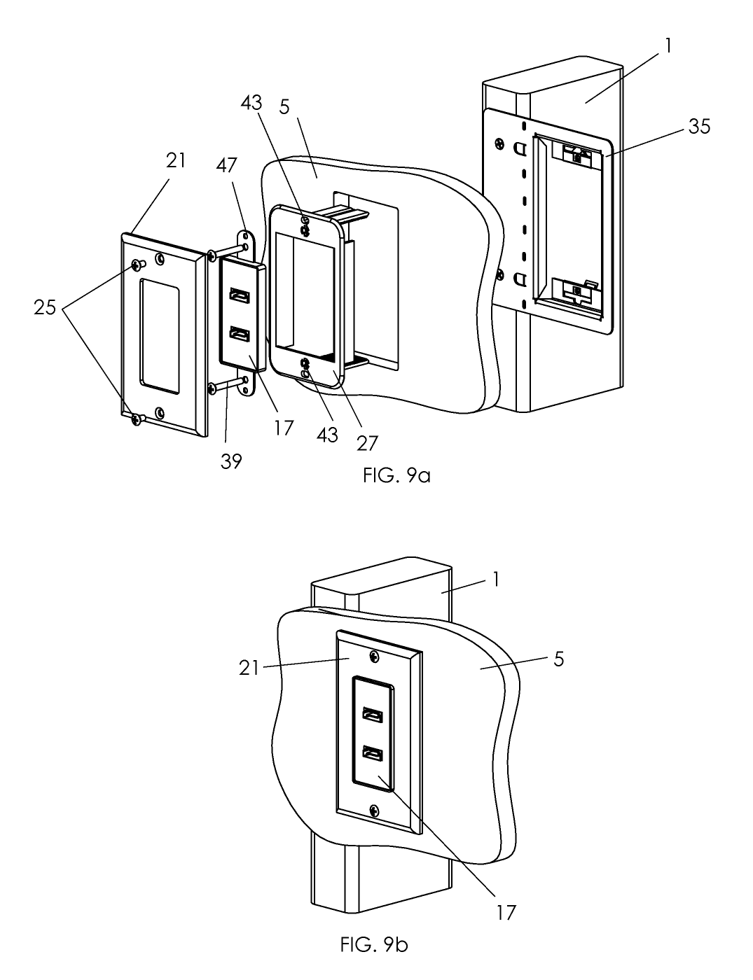

A further assembly embodiment is illustrated by FIGS. 9a-b and 10a-d. As can be seen most clearly in the detail view of FIG. 10d, tongue 53 of frame 27 contains inwardly facing toothed surface 37. Sprung retainer 31 of bracket member 35 comprises removal flange 32. Frame 27 can be removed from bracket 35 by inserting tip 20 of screwdriver 19 through a hole or slot in removal flange 32. By levering screwdriver 19, sprung retainer 31 via removal flange 32 is pulled from teeth 37 liberating frame 27. Speed nut 43, integral to frame 27, allows device mounting screws 39 to be pushed in most of the way, then tightened with a partial rotation of screwdriver. Speed nut 43 may comprise a plurality of sloped plastic cantilevered arms with partial threads that engage threads of the screw. Upon tightening by a partial turn with a screwdriver, the speed nut retains the screw.

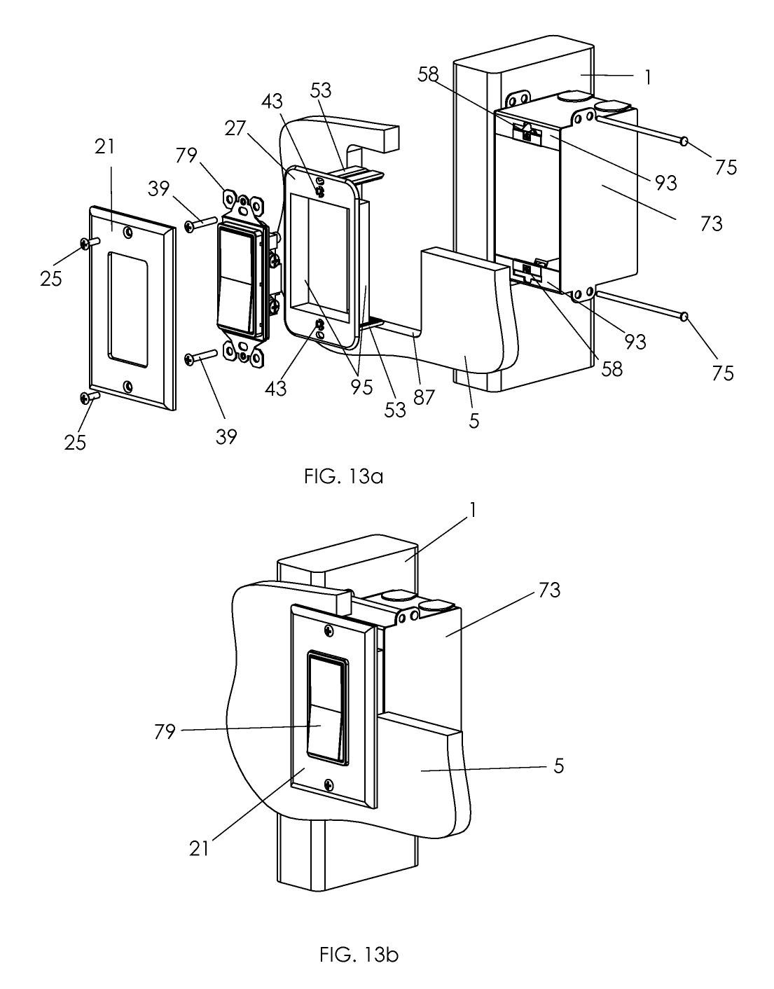

An assembly for new building construction use with a line voltage electrical device is illustrated in FIGS. 13a-b. Electrical box 73 is fastened with nails 75, or the like, to stud 1 behind drywall 5. A rotating bit (not shown), may be guided around the outside perimeter of box 73, to cut hole 87 in drywall 5. A standoff (not shown) from stud 1 permits passage of the bit between stud 1 and box 73. Frame 27 comprises tongues 53 that extend from the top and bottom. Tongues 53 have inwardly facing teeth that are retained with sprung retainers on retainer assembly 58 in box 73. A perimeter flange 95 of frame 27, perpendicular to its front face extends into hole 87 in drywall 5 and into box 73, thereby enclosing sides of the installation through the thickness of drywall as required for line voltage devices by standard electrical code. Line voltage switch device 79 is fastened into frame 27 with screws 39. Internal ratcheting thread 43 is integral to frame 27, allowing for push insertion of fastener 39 and limited rotation tightening with a screwdriver. Cover plate 21 is fastened to device 79 with screws 25. Similar to the operation illustrated by FIGS. 10a-d, frame 27 can be removed from box 73. Alternatively, retainer assembly 58, comprising sprung retainer 31 and tongue support 41 with removal flange 32, such as illustrated in FIGS. 10a-d, and support surface 93, can be recessed to permit cutting of hole 87 in drywall 5 along the inside perimeter of box 73.

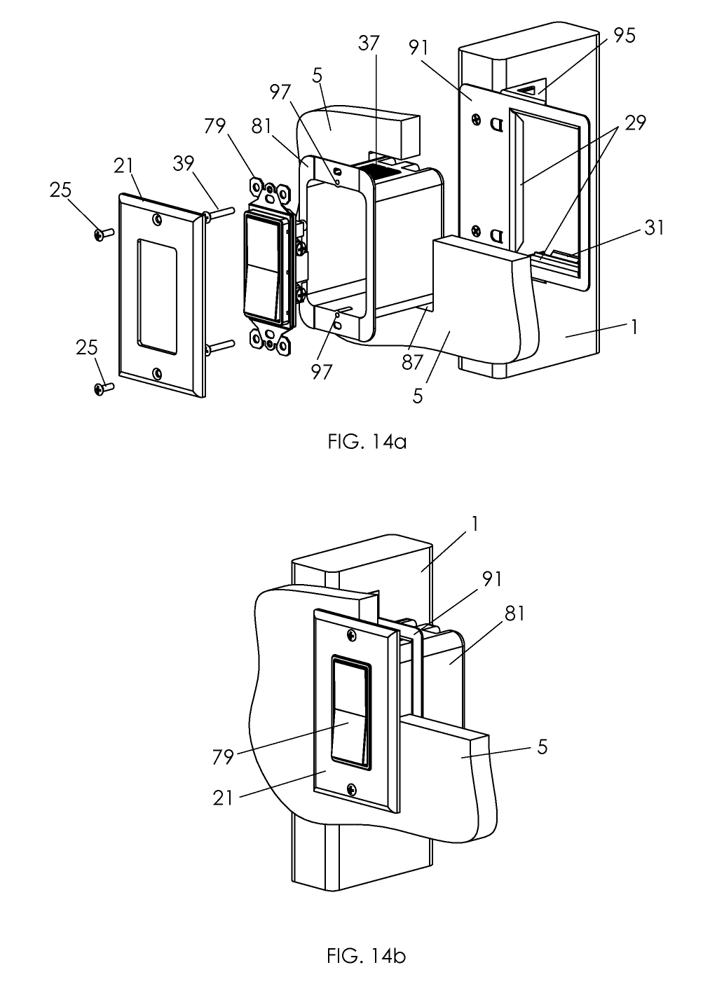

Yet another embodiment is illustrated in FIGS. 14a-b. Bracket member 91 is mounted to stud 1. Line voltage electrical box 81 is engaged with sprung retainers 31 of bracket member 91. Sprung retainers 31 on the inside top and inside bottom are recessed to permit cutting of hole 87 on the inside perimeter flange 29. Thereafter, electrical box 81 can be pushed into bracket 91. Gussets 95 on the top and bottom of bracket 91 provide structure sufficient to facilitate pushing box 81 into position. Teeth 37 on the top and bottom surfaces of box 81 engage sprung retainers 31 and seal the front flange of box 81 against drywall 5. Electrical device 79 can then be secured to box 81 with threaded fasteners 39 in threaded holes 97. Cover plate 49 is secured with fasteners 25. To remove box 81, similar to the operation described with respect to FIGS. 8a-c, a long small diameter tool can be inserted in holes 97 to disengage sprung retainer 31 from teeth 37.

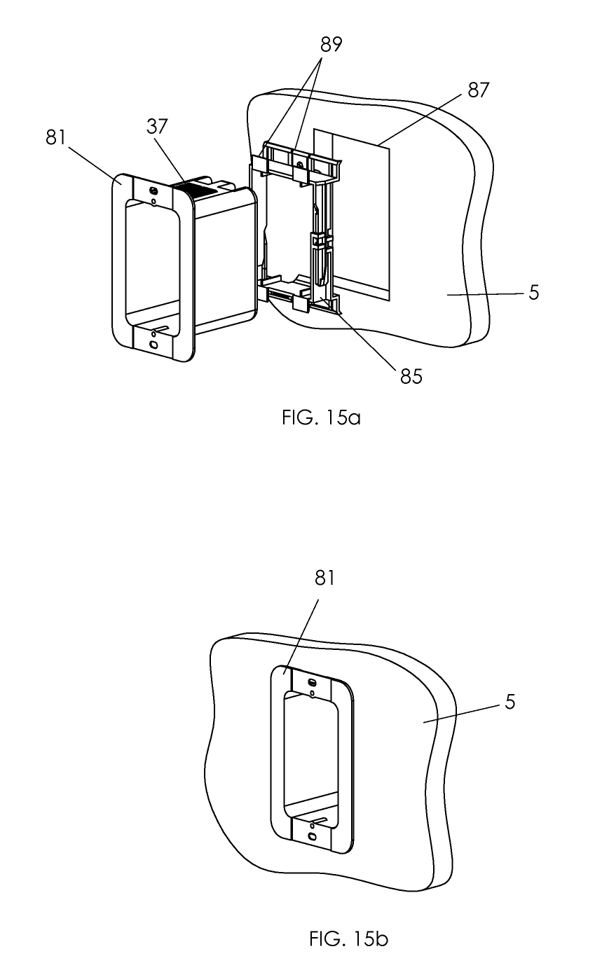

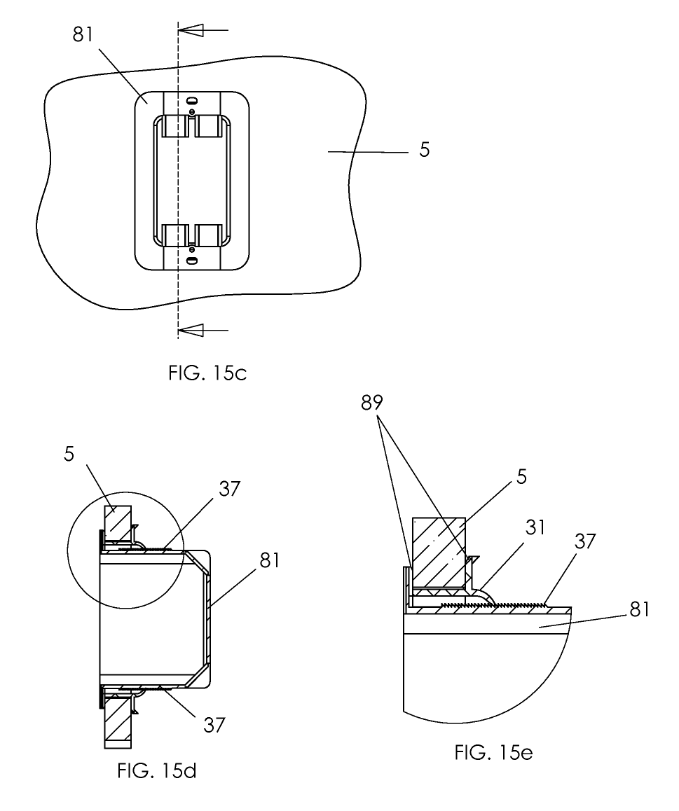

A variation of the assembly of FIGS. 14a-b is illustrated in FIGS. 15a-e. Electrical box 81 is mounted with sprung retainers 31 on the inside top and bottom of an expandable frame 85 that is coupled to drywall hole 87. Frame 85 comprises front and back flanges 89 that apply pressure to the front and back surfaces of drywall 5 at the top and bottom of hole 87 to securing frame 85 in place. Expanded frame 85 locks in relation to itself to prevent compression thereof.

In this disclosure there are shown and described only preferred embodiments of the invention and but a few examples of its versatility. It is to be understood that the invention is capable of use in various other combinations and environments and is capable of changes or modifications within the scope of the inventive concept as expressed herein. For example, bracket members may be utilized that do not require inwardly extending flanges. In such instances, the drywall cutting bit depth is adjusted so that the guide tip runs along the inside perimeter of the opening in the bracket. Moreover, although the bracket opening has been illustrated as a generally rectangular configuration, it is to be understood that other opening configurations are within the concepts of this disclosure.

What is claimed is:

1. An electrical device support structure comprising:
a bracket member having an opening traversing first and second opposite planar surfaces thereof, a portion of the bracket member configured to be mounted to a building wall stud in contact with the first said planar surface, the second said planar surface flush with a wall substrate.

2. An electrical device support structure as recited in claim 1, wherein the bracket member further comprises a plurality of flange elements extending from the opening in an internal direction from the wall substrate, the flange elements defining the periphery of an opening in the wall substrate.

3. An electrical device support structure as recited in claim 2, wherein the flange elements are integral with the edge of the bracket member opening.

4. An electrical device support structure as recited in claim 2, wherein the bracket member further comprises a plurality of retainers configured to link with of an object external to the wall substrate.

5. An electrical device support structure as recited in claim 4, wherein the plurality of retainers comprise sprung elements.

6. An electrical device support structure as recited in claim 5, wherein the sprung elements are recessed inwardly from the edge of the bracket member opening.

7. An electrical device support structure as recited in claim 4, wherein each of said retainers comprises first and second sprung elements configured to engage an extension member of the object inserted through the wall substrate opening.

8. An electrical device support structure as recited in claim 7, wherein the first sprung element comprises a slotted flange.

9. An electrical device support structure as recited in claim 1, further comprising means for aligning the bracket member with a side of the building wall stud.

10. An electrical device support structure as recited in claim 1, wherein the side portion comprises perforations configured for detachment of the side portion from the bracket member to facilitate mounting the bracket member at a wall portion remote from the stud.

11. An electrical device support structure as recited in claim 1, wherein the bracket member further comprises a generally perpendicular gusset member formed at a side of the bracket member periphery for mounting thereof to a side of the stud.

12. An electrical device support structure as recited in claim 1, wherein the bracket member further comprises at least one threaded feature for attachment to an object external to the wall substrate.

13. An electrical device support structure as recited in claim 1, wherein the threaded feature comprises a speed nut integral with the bracket member.

14. An electrical device support structure comprising:
a bracket member having an opening between first and second opposite surfaces thereof, a portion of the bracket member configured to be mounted to a building wall stud in contact with the first said surface, the bracket member comprising a plurality of flange elements extending from the opening in an internal direction from a wall substrate, the flange elements defining the periphery of an opening in the wall substrate.

15. An electrical device support assembly comprising:
a bracket member having an opening traversing first and second opposite planar surfaces thereof, a portion of the bracket member configured to be mounted to a building wall stud in contact with the first said planar surface, the second said planar surface flush with an inner surface of a wall substrate; and
a frame external to the wall substrate, said frame engageable with the bracket member.

16. An electrical device support assembly as recited in claim 15, wherein the bracket member further comprises a plurality of flange elements extending from the opening in an internal direction from the wall substrate, the flange elements defining the periphery of an opening in the wall substrate.

17. An electrical device support assembly as recited in claim 16, wherein the flange elements are integral with the edge of the bracket member opening.

18. An electrical device support assembly as recited in claim 16, wherein the frame comprises a plurality of tongue elements extending in an inward direction from the wall substrate; and
the bracket member further comprises a plurality of retainers configured to link with corresponding tongue elements of the frame.

19. An electrical support assembly as recited in claim 18, wherein each of the tongue elements comprises a toothed surface and each of the plurality of retainers comprises a corresponding sprung element for engaging the toothed surface.

20. An electrical device support assembly as recited in claim 19, wherein the sprung elements are recessed inwardly from the edge of the bracket member opening.

21. An electrical device support assembly as recited in claim 19, wherein each of said retainers comprises a plurality of sprung elements.

22. An electrical device support assembly as recited in claim 21, wherein a first of said plurality of sprung elements comprises a slotted flange.

23. An electrical device support assembly as recited in claim 15, wherein said bracket member comprises means for aligning the bracket member with a side of the building wall stud.

24. An electrical device support assembly as recited in claim 15, wherein the bracket member comprises a side portion configured for mounting to the wall stud, the side portion having perforations configured for detachment of the side portion from the bracket member to facilitate mounting the bracket member at a wall portion remote from the stud.

25. An electrical device support assembly as recited in claim 15, wherein the bracket member further comprises a generally perpendicular gusset member formed at a side of the bracket member periphery for mounting thereof to a side of the stud.

26. An electrical device support assembly as recited in claim 15, wherein the frame comprises at least one engagement component for mating with an electrical device.

27. An electrical device support assembly as recited in claim 15, wherein the bracket member further comprises at least one threaded feature for attachment to an object external to the wall substrate.

28. An electrical device support assembly as recited in claim 27, wherein the threaded feature comprises a speed nut integral with the bracket member.
